(19) United States
(12) Patent Application Publication
(10) Pub. No.: US 2021/0327642 A1
(43) Pub. Date: Oct. 21, 2021

(54) WINDING BODY AND METHOD FOR MANUFACTURING WINDING BODY, AND COIL COMPONENT

(71) Applicant: Murata Manufacturing Co., Ltd., Kyoto-fu (JP)

(72) Inventors: Gota SHINOHARA, Nagaokakyo-shi (JP); Kenichiro MAKI, Nagaokakyo-shi (JP)

(73) Assignee: Murata Manufacturing Co., Ltd., Kyoto-fu (JP)

(21) Appl. No.: 17/234,249

(22) Filed: Apr. 19, 2021

(30) Foreign Application Priority Data
Apr. 20, 2020 (JP) 2020-074657

(51) Int. Cl. H01F 27/28; H01F 27/24; H01F 27/32; H01F 41/063

(52) U.S. Cl. CPC H01F 27/2823; H01F 41/063; H01F 27/323; H01F 27/24

(57) ABSTRACT

A winding body and method to avoid short-circuiting due to contact between conductors, and to suppress occurrence of structural defects such as cracks. A continuous thin band is folded at a folding site and wound helically. The folding site has a cutout portion, and folding at the folding site so that a conductor portion overlap another conductor portion causes the cutout portion to be formed into a recessed portion having a larger space than a gap between the conductor portions. A part of the conductor inside the folding site can be stowed in the recessed portion. The continuous thin band has a thickness desirably equal to or less than twice a skin depth with respect to a driving frequency of a coil component.

### CROSS-REFERENCE TO RELATED APPLICATION

This application claims benefit of priority to Japanese Patent Application No. 2020-074657, filed Apr. 20, 2020, the entire content of which is incorporated herein by reference.

### BACKGROUND

### Technical Field

The present disclosure relates to a winding body and a method for manufacturing the winding body, and a coil component. More specifically, the present disclosure relates to a winding body for a coil component with a seamless thin band wound helically (hereinafter, this seamless thin band is referred to as a “continuous thin band”) and a method for manufacturing it, and a coil component such as a reactor using the winding body.

### Background Art

In recent years, coil components have been mounted on various electronic devices, and widely used as key components of a high-frequency transformer and a vehicle inverter, for example. Coil conductors are incorporated in the coil components, and research and development on the coil conductors have been actively carried out.

For example, a high-frequency transformer including a coil with a longitudinal winding structure having a helical winding around a center leg of an iron core is suggested in Japanese Patent Application Laid-Open No. 2013-21307 (claim 1, paragraphs [0007], [0018] to [0021], FIG. 1, etc.).

In Japanese Patent Application Laid-Open No. 2013-21307, a primary side coil and a secondary side coil are electromagnetically coupled, and are each formed of a seamless band-like conductor plate having a substantially rectangular section. The band-like conductor plate is folded toward a front side or a back side with respect to a current carrying direction, and is folded toward the same side at least one more time in one turn of the coil.

FIG. 25 shows an example of the band-like conductor plate after folding.

A flattened band-like conductor plate 101 is provided with a plurality of folding lines 102a, 102b, 102c, . . . , which divide the band-like conductor plate 101 into a plurality of conductor portions 103a, 103b, 103c, . . . .

This band-like conductor plate 101 is folded and wound helically as follows. That is, a right-angled valley fold is made so that the folding line 102a provided at a boundary between the conductor portion 103a and the conductor portion 103b is hidden inside, and the conductor portion 103b and the consecutive conductor portions are extended in a horizontal direction. Next, another right-angled valley fold is made along the folding line 102b provided at a boundary between the conductor portion 103b and the conductor portion 103c in the same manner as described above, and the conductor portion 103c and the consecutive conductor portions are extended parallel to the conductor portion 103a. Hereinafter, similarly at least two consecutive valley folds or at least two consecutive mountain folds are made at one of the front side or the back side, and the band-like conductor plate 101 is wound helically so as to surround the center leg of the iron core (not shown), resulting in production of a coil conductor.

Further, a flat coil body for a coil component as shown in FIG. 26 is suggested in Japanese Patent Application Laid-Open No. 2001-338811 (claim 3, paragraphs [0028] to [0030], [0042] to [0044], FIGS. 2, 3, etc.).

This flat coil body has a sheet-like conductor pattern 111 wound helically, and a rectangular cylindrical cavity (hollow portion) 112 provided therethrough for core member penetration. That is, the conductor pattern 111 consists of a large number of conductor portions 113a, 113b, . . . with rectangular through holes 114a, 114b, . . . formed in central portions of the conductor portions 113a, 113b, . . . , respectively. The conductor portions 113a, 113b, . . . have cut portions 115a, 115b, . . . each formed at any one of corner portions forming the respective through holes 114a, 114b, . . . . Then, for example, the conductor portion 113a is connected to the conductor portion 113b at a lower end where the cut portion 115a is located, the conductor portion 113b is connected to the conductor portion 113c at a right end where the cut portion 115b is located, the conductor portion 113c is connected to the conductor portion 113d at an upper end where the cut portion 115c is located, and the conductor portion 113d is connected to the conductor portion 113e at a left end where the cut portion 115d is located.

The flat coil body is produced as follows.

That is, first, the conductor pattern 111 is cut out from a conductive sheet-like member. Next, the cut portions 115a, 115b, . . . and the through holes 114a, 114b, . . . are formed at respective predetermined positions.

FIG. 27 is a developed view of a relevant part of the flat coil body, in which the cut portions 115a, 115b, . . . and the through holes 114a, 114b, . . . are formed in the conductor pattern 111 cut out into a predetermined shape.

A folding site 116 as a folding line undergoes fold processing to be a mountain fold, and a folding site 117 as a folding line then undergoes fold processing to be a valley fold. Hereinafter, a mountain fold and a valley fold are repeatedly made a predetermined number of times and then press processing is performed for manufacturing the helical flat coil body.

### SUMMARY

However, in Japanese Patent Application Laid-Open No. 2013-21307, as shown in FIG. 25 described above, for example, the right-angled fold is made between the conductor portion 103a and the conductor portion 103b along the folding line 102a, and the right-angled fold is made between the conductor portion 103b and the conductor portion 103c along the folding line 102b, resulting in formation of an overlapping portion 105a between the conductor portion 103a and the conductor portion 103b and an overlapping portion 105b between the conductor portion 103b and the conductor portion 103c. In this case, some parts of the conductor hidden inside at the folding lines 102a and 102b are compressed and crushed by the fold processing, but other parts thereof protrude in a width direction (perpendicular to a folding direction). Thus, there is a risk that the parts of the conductor will come into contact with each other to cause a short circuit. Further, a compressive stress is applied to the folding lines 102a and 102b during folding, which may cause structural defects such as cracks in the inside parts of the conductor along the folding lines 102a and 102b.

Also, in Japanese Patent Application Laid-Open No. 2001-338811, the continuous thin band is simply folded into a mountain fold or a valley fold, and the same problem may occur as in Japanese Patent Application Laid-Open No. 2013-21307.

FIG. 28 is a sectional view taken along the line x-x of FIG. 27. FIG. 29A shows an example of the flat coil body after folding, and FIG. 29B is a sectional view taken along the line y-y of FIG. 29A.

In Japanese Patent Application Laid-Open No. 2001-338811, the folding site 116 is provided between the conductor portion 113a and the conductor portion 113b.

In Japanese Patent Application Laid-Open No. 2001-338811, as shown in FIG. 29A, the fold is made along the folding site 116 as a folding line so that the conductor portion 113b faces the conductor portion 113a, and the conductor portion 113a and the conductor portion 113b overlap each other. This causes, as shown in part a in the figure, an inside part of the conductor of the folding site 116 to protrude in the width direction from a gap between the conductor portion 113a and the conductor portion 113b. Thus, there is a risk that the conductors of the flat coil body will come into contact with each other to cause a short circuit.

Further, since the compressive stress is applied to the conductor portions 113a, 113b, . . . by the fold processing, a crack originating at the folding site 116 easily arises in the conductor portion 113a and the conductor portion 113b, which may cause structural defects as in Japanese Patent Application Laid-Open No. 2013-21307.

The present disclosure has been made in view of such circumstances, and an object of the present disclosure is to provide a high-performance and high-quality winding body in which short-circuiting due to contact between the conductors and the occurrence of structural defects such as cracks can be suppressed, and a method for manufacturing the winding body, and a coil component such as a reactor using this winding body.

Accordingly, a winding body according to the present disclosure is a winding body for a coil component with a continuous thin band wound helically, the continuous thin band having a plurality of folding sites and being divided into a plurality of conductor portions by the folding sites to be folded in an overlapping manner, the folding sites each having a recessed portion.

This allows for stowing a part of the conductor inside the folding site in the recessed portion, and thus for suppressing protrusion of the part of the conductor to the outside. Therefore, it is possible to avoid contact between the conductors located inside the folding sites and to suppress short-circuiting in the winding. In addition, when a compressive stress is applied to the folding site of the continuous thin band by the fold processing, the recessed portion acts as a buffer, leading to a reduction in the compressive stress. Therefore, it is possible to suppress the occurrence of structural defects such as cracks.

Further, in the winding body of the present disclosure, the recessed portion may be desirably formed into a hollow shape.

Further, in the winding body of the present disclosure, the recessed portion may desirably have an average depth larger than a gap formed between the conductor portions.

Making the average depth of the recessed portion larger than the gap formed between the conductor portions in this way allows for more effectively suppressing protrusion of the part of the conductor hidden inside the folding site to the outside, and for stowing the part of the conductor in the recessed portion. In addition, the compressive stress applied to the inside of the folding site during the fold processing can be further reduced, which can more effectively suppress the occurrence of structural defects such as cracks.

Further, in the winding body of the present disclosure, the recessed portion may be desirably at least partly filled with insulating resin.

This allows for, when this winding body is attached to a coil component such as a reactor, efficiently releasing heat generated in the winding body to the outside, and thus heat dissipation can be improved.

Further, in the winding body of the present disclosure, the continuous thin band may be desirably formed into a stepped shape with at least successive two of the conductor portions as one pair in a sheet-like unfolded state, and the continuous thin band in the stepped shape may be desirably folded at the folding sites.

This allows for, by repeatedly making a mountain fold and a valley fold at the folding sites in an arbitrary order, easily obtaining the desired winding body having the recessed portions formed at the folding sites.

Further, in this type of coil component, as a driving frequency increases, a current flowing through the coil is concentrated toward a surface of the coil conductor due to the skin effect, and has difficulty in flowing inside. Thus, in order to reduce conductor loss, it is desirable to reduce a thickness of the continuous thin band.

The present inventors have carried out further diligent research from this point of view, and have found that the conductor loss can be effectively reduced by making the thickness of the continuous thin band equal to or less than twice a skin depth with respect to the driving frequency of the coil component.

That is, in the winding body of the present disclosure, the continuous thin band may be desirably formed to have a thickness equal to or less than twice a skin depth with respect to a driving frequency of the coil component.

Further, in the winding body of the present disclosure, the continuous thin band may desirably have the thickness equal to or greater than the skin depth at the driving frequency.

This allows for ensuring workability without making the continuous thin band excessively thin, and for obtaining the winding body with low conductor loss.

Further, the winding body of the present disclosure may desirably have a rectangular wire shape.

That is, since a rectangular wire has a larger conductor space factor than a round wire, forming the winding body using the rectangular wire allows for reduction in a winding resistance without impairing the workability.

Further, the winding body of the present disclosure may desirably have a surface coated with an insulating film.

The recessed portion in the winding body can be formed by forming a cutout portion in at least a part of the folding site of the continuous thin band and performing the fold processing here, which can lead to efficient production of the winding body.

That is, a method for manufacturing a winding body according to the present disclosure is a method for manufacturing a winding body for a coil component by which the winding body is produced through folding and helically winding a continuous thin band, the method including steps of cutting out the continuous thin band into a predetermined shape to provide cavity portions, forming a cutout portion in at least a part of a folding site where the continuous thin band is folded, and folding the continuous thin band at the folding site to form it into a helical shape with the cutout portion formed into a recessed portion and with the cavity portions communicating with each other.

This allows for, as described above, efficiently manufacturing a winding body with the good workability in which no short circuit in the winding occur and the occurrence of structural defects such as cracks is suppressed.

Further, the method for manufacturing a winding body of the present disclosure may desirably include at least partly filling the recessed portion with insulating resin.

Further, in the method for manufacturing a winding body of the present disclosure, the predetermined shape may desirably be stepped.

Further, in the method for manufacturing a winding body of the present disclosure, the cutout portion may be desirably formed to have a U-shaped section in a direction perpendicular to the folding site.

Further, in the method for manufacturing a winding body of the present disclosure, the continuous thin band may desirably have a thickness equal to or less than twice a skin depth with respect to a driving frequency of the coil component.

Further, a coil component according to the present disclosure is a coil component including a magnetic core containing magnetic material, and a coil conductor, the coil conductor being formed of the winding body described above.

Further, the coil component of the present disclosure may desirably be a reactor.

According to a winding body of the present disclosure, there is provided a winding body for a coil component including a continuous thin band wound helically, the continuous thin band having a plurality of folding sites and being divided into a plurality of conductor portions by the folding sites to be folded in an overlapping manner, the folding sites each having a recessed portion. Therefore, it is possible to stow a part of the conductor inside the folding site in the recessed portion, to suppress protrusion of the part of the conductor to the outside, and thus to suppress short-circuiting in the winding. In addition, when a compressive stress is applied to the folding site of the continuous thin band by the fold processing, the recessed portion acts as a buffer, leading to a reduction in the compressive stress. Therefore, it is possible to suppress the occurrence of structural defects such as cracks.

Further, according to a method for manufacturing a winding body of the present disclosure, there is provided a method for manufacturing a winding body for a coil component by which the winding body is produced through folding and helically winding a continuous thin band. The method includes steps of cutting out the continuous thin band into a predetermined shape to provide cavity portions, forming a cutout portion in at least a part of a folding site where the continuous thin band is folded, and folding the continuous thin band at the folding site to form it into a helical shape with the cutout portion formed into a recessed portion and with the cavity portions communicating with each other. Therefore, it is possible to efficiently manufacture a winding body with the good workability in which short-circuiting in the winding and the occurrence of structural defects such as cracks are suppressed.

Further, according to a coil component of the present disclosure, there is provided a coil component including a magnetic core containing magnetic material, and a coil conductor which is formed of the winding body described above. Therefore, it is possible to obtain a high-performance and high-quality coil component such as a reactor in which protrusion of a part of the conductor of the winding body to the outside can be suppressed, short-circuiting in the winding can thus be avoided, and the occurrence of structural defects such as cracks are also suppressed.

### BRIEF DESCRIPTION OF THE DRAWINGS

FIG. 1 is a perspective view schematically showing an embodiment of a winding body according to the present disclosure;

FIG. 2 is a sectional view taken along the line A-A of FIG. 1;

FIG. 3 is a developed view of a continuous thin band that is unfolded in a sheet-like shape;

FIG. 4 is an enlarged view of part B of FIG. 3;

FIG. 5 is an enlarged view of part C of FIG. 4;

FIG. 6 is a sectional view taken along the line D-D of FIG. 5;

FIG. 7 is a sectional view of a relevant part of the winding body, showing an exemplary state in which conductor portions overlap each other;

FIG. 8 is an exploded perspective view of the winding body;

FIGS. 9A to 9C are outline views showing an embodiment of a procedure for producing a continuous thin band;

FIGS. 10D to 10F are sectional views of a relevant part showing an embodiment of a procedure for producing a winding body, and show an exemplary section parallel to an axial direction of the winding;

FIG. 11 is a perspective view showing an embodiment of a reactor as a coil component according to the present disclosure;

FIG. 12 is a sectional view of a relevant part showing another embodiment of the winding body according to the present disclosure, showing another exemplary state in which conductor portions overlap each other;

FIG. 13 is an image of a folding site of a Cu thin band of Example 1 obtained with an optical microscope;

FIG. 14 is an image of the Cu thin band of FIG. 13 showing a state during folding obtained with the optical microscope;

FIG. 15 is an image of the Cu thin band of FIG. 13 showing a state after folding obtained with the optical microscope;

FIG. 16 is an SEM image of a section of the Cu thin band of FIG. 13 after folding obtained with a scanning electron microscope (SEM);

FIG. 17 is an enlarged SEM image for FIG. 16;

FIG. 18 is an image of a folding site of a Cu thin band of a comparative example obtained with the optical microscope;

FIG. 19 is an image of the Cu thin band of FIG. 18 showing a state during folding obtained with the optical microscope;

FIG. 20 is an image of the Cu thin band of FIG. 18 showing a state after folding (No. 1) obtained with the optical microscope;

FIG. 21 is an image of the Cu thin band of FIG. 18 showing a state after folding (No. 2) obtained with the optical microscope;

FIG. 22 is an SEM image of a section of the Cu thin band of FIG. 18 after folding obtained with the SEM;

FIG. 23 is an enlarged SEM image for FIG. 22;

FIG. 24 is a diagram showing a relationship between a thickness and a conductor loss of the Cu thin band in Example 2;

FIG. 25 is a side view showing the band-like conductor plate described in Japanese Patent Application Laid-Open No. 2013-21307;

FIG. 26 is a perspective view of the flat coil body described in Japanese Patent Application Laid-Open No. 2001-338811;

FIG. 27 is a developed view of a relevant part of the flat coil body described in Japanese Patent Application Laid-Open No. 2001-338811;

FIG. 28 is a sectional view taken along the line x-x of FIG. 27; and

FIGS. 29A and 29B are views for explaining the problem of Japanese Patent Application Laid-Open No. 2001-338811.

### DETAILED DESCRIPTION

Next, embodiments of the present disclosure will be described in detail.

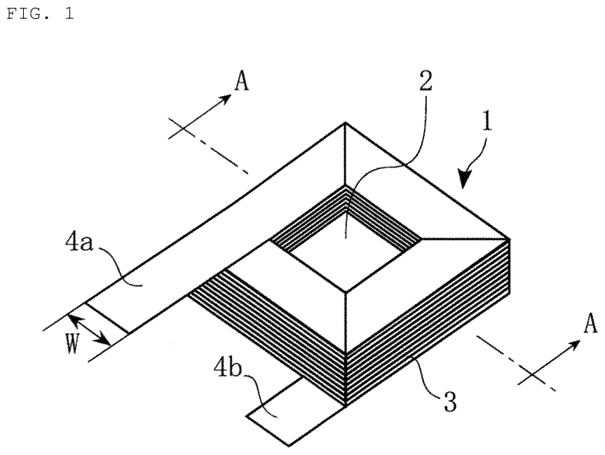

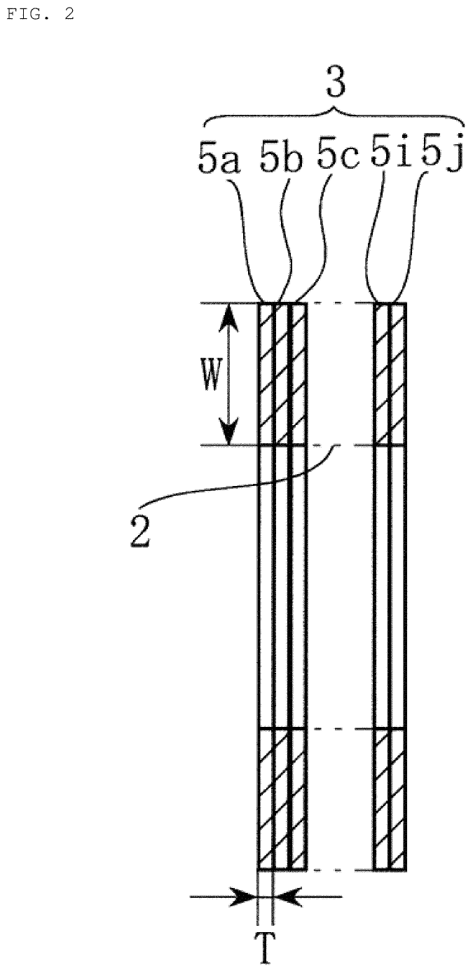

FIG. 1 is a perspective view showing an embodiment of a winding body for a coil component according to the present disclosure, and FIG. 2 is a sectional view taken along the line A-A of FIG. 1.

This winding body, in which a continuous thin band 1 is wound helically to form a hollow portion 2, has a winding portion 3 where the continuous thin band 1 is wound and extended portions 4a and 4bformed at both ends of the winding portion 3, and is formed into a rectangular cylindrical shape in appearance. That is, the continuous thin band 1 is provided with a plurality of folding sites as described later, and is divided into a plurality of conductor portions 5a to 5j by the folding sites. In the winding body, the continuous thin band 1 is folded in an overlapping (folding over) manner at the folding sites to have the extended portions 4a and 4band the conductor portions 5a to 5j each having a flat rectangular wire shape with a width W and a thickness T. The plurality of conductor portions 5a to 5j are electrically connected to each other.

In recent years, coil components are expected to have higher performance while a driving frequency thereof has been increasing, which leads to a requirement for reduction of the conductor loss in the coil components. However, when an alternating current is flowing through a winding body, as a driving frequency increases, the current is concentrated toward a surface due to the skin effect, and the farther away from the surface, the greater an electrical resistance and the less the current flows. As described above, in this type of coil component, when the winding body is energized, as the driving frequency of the coil component increases, the current is concentrated toward a surface of the winding body due to the skin effect, resulting in a reduction of an effective sectional area of the winding body. Thus, the electrical resistance and the conductor loss may increase, and quality may deteriorate. Hence, a rectangular wire, which has a larger conductor occupancy than a round wire and allows for reduction of a winding resistance, is desirably used as a conductive wire. Further, when a rectangular wire is used, in order to efficiently carry the current distributed near the surface due to the skin effect, it is desirable to reduce the thickness T and to increase the width W of the extended portions 4a and 4band the conductor portions 5a to 5j.

Thus, a rectangular wire having a large ratio of the width W to the thickness T, or equivalently, a large aspect ratio W/T is desirably used for the winding body. However, helically winding the rectangular wire having the large aspect ratio W/T to produce the winding body is technically difficult.

It is thus considered desirable to fold the continuous thin band 1 of the thickness T cut out into a predetermined shape to produce the winding body having the extended portions 4a and 4band the conductor portions 5a to 5j each having a rectangular wire shape.

However, as described in the section, simply folding the continuous thin band 1 and making the conductor portions 5a to 5j overlap each other may cause a part of the conductor inside the folding site to protrude in the width direction, or may cause structural defects such as cracks due to a compressive stress applied during the fold processing.

Thus, in the present embodiment, the continuous thin band 1 having the plurality of folding sites is folded at the folding sites in an overlapping manner so that the extended portions 4a and 4band the conductor portions 5a to 5j constituting the winding body have a rectangular wire shape, and recessed portions are formed at the folding sites. That is, forming the recessed portion in the folding site allows for stowing the part of the conductor inside the folding site in the recessed portion, which suppresses protrusion of the part of the conductor to the outside, and for alleviating the compressive stress applied during the fold processing, which suppresses the occurrence of structural defects such as cracks.

Further, the thickness T of the extended portions 4a and 4band the conductor portions 5a to 5j, or equivalently, the thickness T of the continuous thin band 1 is not particularly limited as long as the conductor loss can be effectively reduced, but is desirably set to be equal to or less than twice a skin depth d with respect to a driving frequency f of the coil component.

That is, assuming that the driving frequency of the coil component is f (Hz), an electrical resistivity of the continuous thin band 1 is ρ (Ω·m), and an absolute magnetic permeability of the continuous thin band 1 is μ (H/m), the skin depth d (m) is expressed by a mathematical formula (1).

Formula 1

d=\sqrt{2ρ/2n f μ} (1)

In this case, if the thickness T of the continuous thin band 1 exceeds twice the skin depth d with respect to the driving frequency f of the coil component, a region where no current flows increases due to the excessively increased thickness T of the continuous thin band 1, resulting in a significant increase in the conductor loss.

On the other hand, if the thickness T of the continuous thin band 1 becomes equal to or less than twice the skin depth d with respect to the driving frequency f, the region where no current flows decreases due to the decreased thickness T of the continuous thin band 1, allowing for a sharp decrease in the conductor loss of the continuous thin band 1.

Hence, the thickness T of the continuous thin band 1 is desirably equal to or less than twice the skin depth d with respect to the driving frequency f of the coil component as described above. For example, consider a case where the continuous thin band 1 is formed of a Cu thin band. Since the electrical resistivity p of Cu is 1.68×10⁻⁸ Ω·m and the absolute magnetic permeability μ of Cu is 1.26×10⁻⁶ H/m, when the driving frequency f of the coil component is 200 kHz (2.0×10⁵ Hz), the skin depth d will be 0.15 mm according to the mathematical formula (1), and thus the thickness T of the continuous thin band 1 will desirably be 0.3 mm or less. Similarly, when the driving frequency of the coil component is 50 kHz (5.0×10⁴ Hz), the skin depth d will be 0.29 mm, and thus the thickness T of the continuous thin band 1 will desirably be 0.58 mm or less.

A lower limit of the thickness T of the continuous thin band 1 is also not particularly limited, but is desirably set to be, for example, equal to or greater than the skin depth d with respect to the driving frequency fin view of the workability and the like.

The aspect ratio W/T is not particularly limited as long as the thickness T of the continuous thin band 1 is reduced to be desirably equal to or less than twice the skin depth d with respect to the driving frequency f as described above and the width W is increased to be able to ensure a sufficient current carrying amount. The aspect ratio W/T is set to, for example, about 30 to 80.

Core material of the winding body is not particularly limited as long as it has good conductivity. However, Cu, which is inexpensive, is generally used in favor. Further, a surface of the core material is coated with insulating material such as enamel, which ensures insulating property.

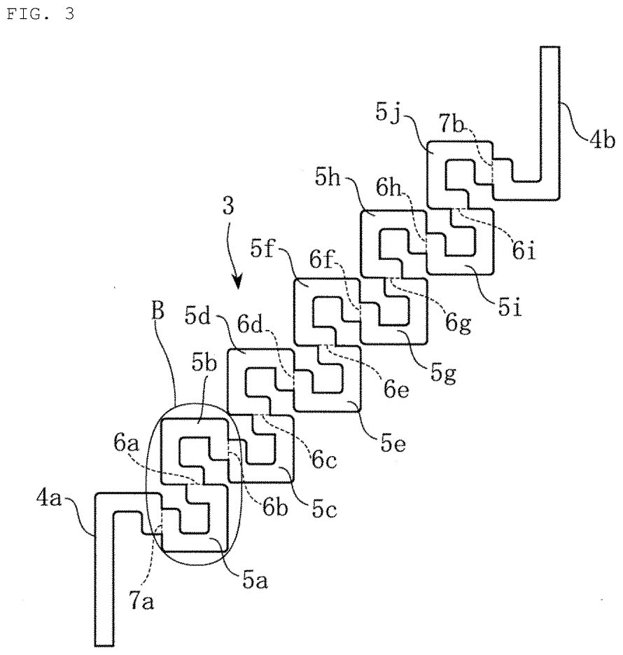

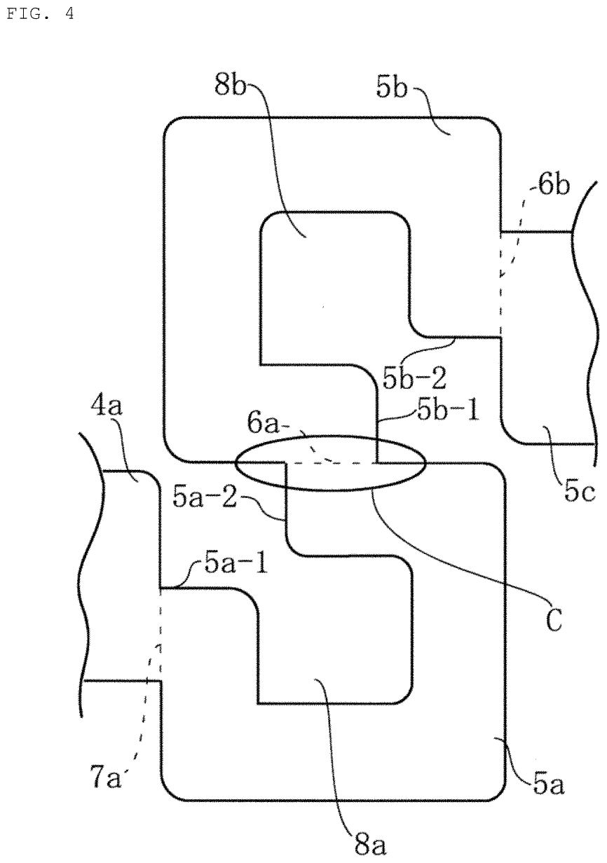

FIG. 3 is a developed view of the continuous thin band 1 that is unfolded in a sheet-like shape, and FIG. 4 is an enlarged view of part B of FIG. 3.

The continuous thin band 1 is provided with the folding sites 7a, 6a to 6i, and 7b that serve as folding lines as described above. Then, the continuous thin band 1 is formed into a predetermined shape so as to be divided into the plurality of conductor portions 5a to 5j by the folding sites 6a to 6i, to have the extended portion 4a connected to the conductor portion 5a via the folding site 7a, and to have the extended portion 4bconnected to the conductor portion 5j via the folding site 7b.

Specifically, the continuous thin band 1 is formed into a stepped shape with successive two of the conductor portions as one pair. For example, as shown in FIG. 4, the conductor portion 5a and the conductor portion 5b have cavity portions 8a and 8b formed in respective central portions thereof, and are each formed by four corner portions of which one has been cut off. In the conductor portion 5a, one end 5a-1 is out of contact with another end 5a-2, and in the conductor portion 5b, one end 5b-1 is out of contact with another end 5b-2. The other end 5a-2 and the one end 5b-1 are connected via the folding site 6a , and thus the successive two of the conductor portions 5a and 5b is continuously formed into a substantially S shape as a whole on a plane. The one end 5a-1 of the conductor portion 5a is connected to the extended portion 4a formed into a substantially L shape via the folding site 7a, and the other end 5b-2 of the conductor portion 5b is connected to the conductor portion 5c via the folding site 6b. Hereinafter, similar successive two of the conductor portions on the plane is connected via the folding site to another successive two of the conductor portions on the plane adjacent in a stepped manner, and the terminal conductor portion 5j is connected to the extended portion 4bformed into a substantially L shape via the folding site 7b.

The folding sites 7a, 6a to 6j, and 7b each have a cutout portion formed on one of a front surface and a back surface.

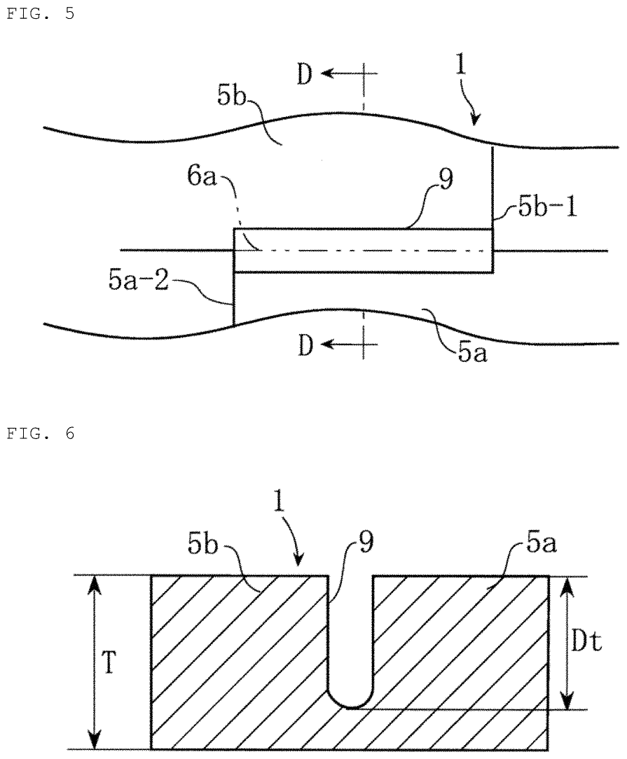

FIG. 5 is an enlarged view of part C of FIG. 4, and FIG. 6 is a sectional view taken along the line D-D of FIG. 5.

In the present embodiment, the thickness T of the continuous thin band 1 is small enough to ensure the workability, and is desirably equal to or less than twice the skin depth d with respect to the driving frequency f of the coil component. The folding site 6a has a cutout portion 9. Specifically, as shown in FIG. 6, this cutout portion 9 is formed to have a U-shaped section in a direction perpendicular to the folding site 6a.

A depth Dt of the cutout portion 9 is not particularly limited as long as the part of the conductor located inside the folding site 6a can be stowed in a recessed portion 10, but is desirably about ¼ to ¾ the thickness T of the continuous thin band 1. When the depth Dt of the cutout portion 9 is less than ¼ the thickness T of the continuous thin band 1, the recessed portion may fail to be sufficiently formed, and when the depth Dt exceeds ¾ the thickness T of the continuous thin band 1, disconnection may occur at the part of the conductor.

The cutout portion 9 is formed in the entire folding site 6 in FIGS. 5 and 6. However, the cutout portion 9 may be formed in a part of the folding site 6 since it is sufficient to cut out at least both ends of the folding site 6a and to suppress the protrusion of the conductor portions 5a and 5b in the width direction as described later.

A method for forming the cutout portion 9 is not particularly limited. For example, the cutout portion 9 can be formed by cutting by milling, by immersing the continuous thin band 1 in an etching liquid with an area other than the folding sites 7a, 6a to 6j, and 7b masked for etching removal, or by pressing a mold of a predetermined shape against the folding sites 7a, 6a to 6j, and 7b to transfer the predetermined shape to the folding sites 7a, 6a to 6j, and 7b.

FIG. 7 is a sectional view of a relevant part of the winding body, showing a state in which the folding site 6a undergoes the fold processing to be a valley fold.

That is, when the continuous thin band 1 is folded into a valley fold by moving the conductor portion 5b toward the conductor portion 5a in FIG. 5 so that the inside of the folding site 6a is hidden, the cutout portion 9 is formed into the hollow recessed portion 10. This hollow recessed portion 10 has a cylindrical shape with a distorted interior, which allows for stowing the inside part of the conductor between the conductor portion 5a and the conductor portion 5b in the recessed portion 10, and thus for suppressing protrusion of the part of the conductor in the width direction of the winding body. Therefore, when the continuous thin band 1 undergoes the fold processing to be wound helically, electrical short-circuiting in the winding body can be suppressed. Further, when a compressive stress is applied to the part of the conductor during the fold processing, the recessed portion 10 acts as a buffer, leading to a reduction in the compressive stress, and the occurrence of structural defects such as cracks in the part of the conductor can be suppressed.

The recessed portion 10 has an average depth Dp desirably larger than an average value of a gap δ between the conductor portion 5a and the conductor portion 5b. That is, since the recessed portion 10 has the distorted cylindrical shape as described above, the average depth Dp can be defined, for example, by an average value of a depth of the recessed portion 10 (for example, a distance from a connection point between the conductor portion 5a and the conductor portion 5b to an inner peripheral surface of the recessed portion, or a maximum distance between any two points on the inner peripheral surface of the recessed portion, etc.) measured at multiple points. Further, the average value of the gap can be easily calculated from measured values, for example, obtained by measuring at multiple points the gap formed by the conductor portion 5a and the conductor portion 5b.

In this way, the recessed portion 10 is formed to have the average depth Dp larger than the average value of the gap S between the conductor portion 5a and the conductor portion 5b, which allows for more effectively suppressing the protrusion of the part of the conductor at the folding sites 7a, 6a to 6j, and 7b in the width direction by the fold processing. Therefore, it is possible to effectively set the part of the conductor in the recessed portion 10, to further reduce the compressive stress applied to the inside of the folding sites 7a, 6a to 6j, and 7b, and to more effectively suppress the occurrence of structural defects such as cracks.

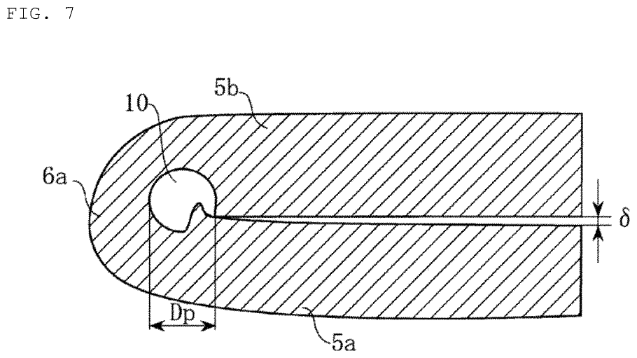

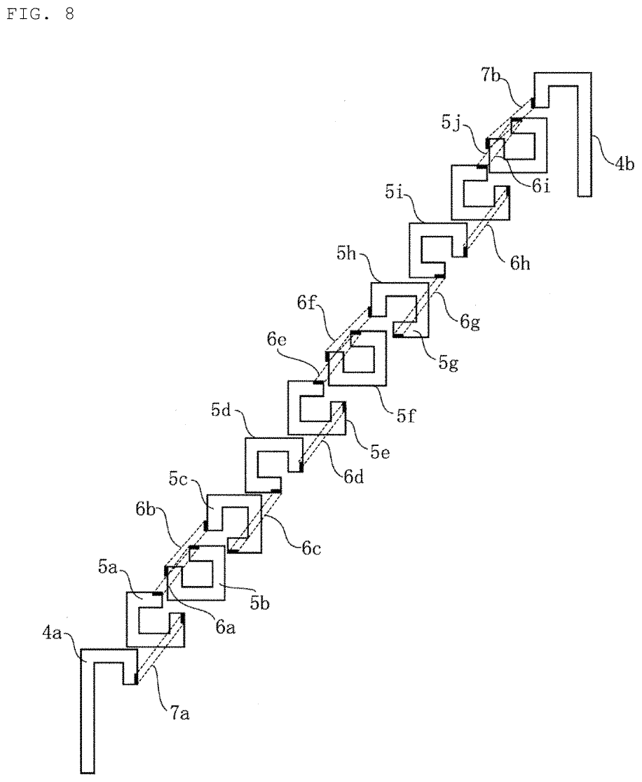

FIG. 8 is an exploded perspective view of the winding body.

A mountain fold and a valley fold are alternately repeatedly made along the folding sites 7a, 6a to 6i, and 7b as folding lines in which the cutout portions 9 are formed. That is, in the developed view of FIG. 3, for example, the continuous thin band 1 is folded into a mountain fold at the folding site 7a so that the extended portion 4a faces and overlaps the conductor portion 5a, and is then folded into a valley fold at the folding site 6a so that the conductor portion 5a faces and overlaps the conductor portion 5b. Hereinafter, a mountain fold and a valley fold are alternately repeatedly made in the same manner, and there are thus provided mountain folds at the folding sites 6b, 6d, 6f, 6h, and 7b, and valley folds at the folding sites 6c, 6e, 6g, and 6i. The conductor portions 5a to 5j are connected via these folding sites 6a, 7a, 6a to 6i, and 7b and are overlapped with each other to form winding with the hollow portion 2, whereby the winding body of the present embodiment is formed.

In the present embodiment as described above, since the recessed portions 10 are formed at the folding sites 7a, 6a to 6i, and 7b, it is possible to stow the parts of the conductor at the folding sites 7a, 6a to 6j, and 7b in the recessed portion 10, to suppress protrusion of the part of the conductor to the outside, and therefore to suppress short-circuiting in the winding. Further, when a compressive stress is applied to folding points of the continuous thin band 1, the recessed portion 10 acts as a buffer, leading to a reduction in the compressive stress. Therefore, the occurrence of structural defects such as cracks can be suppressed.

Next, a method for manufacturing the winding body will be described.

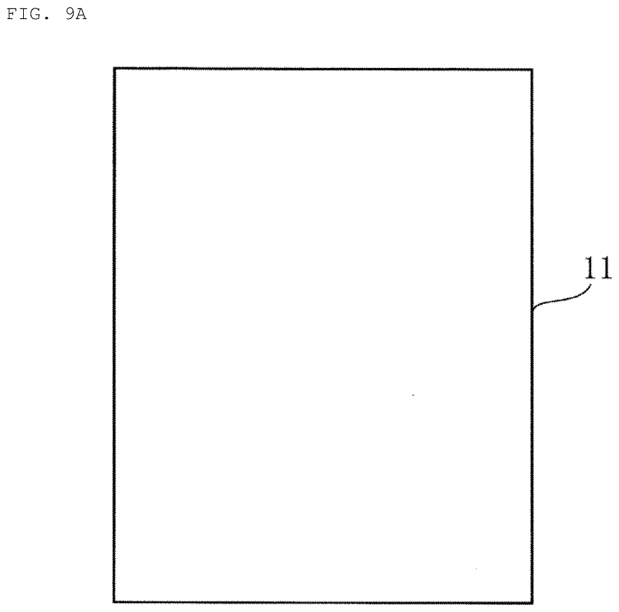

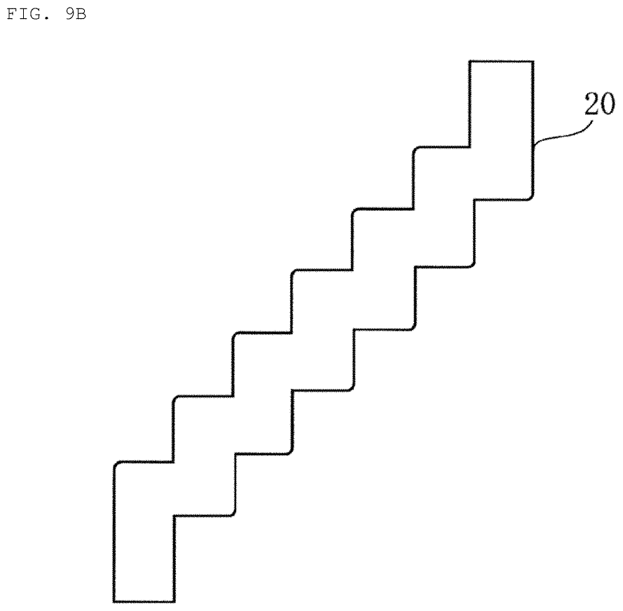

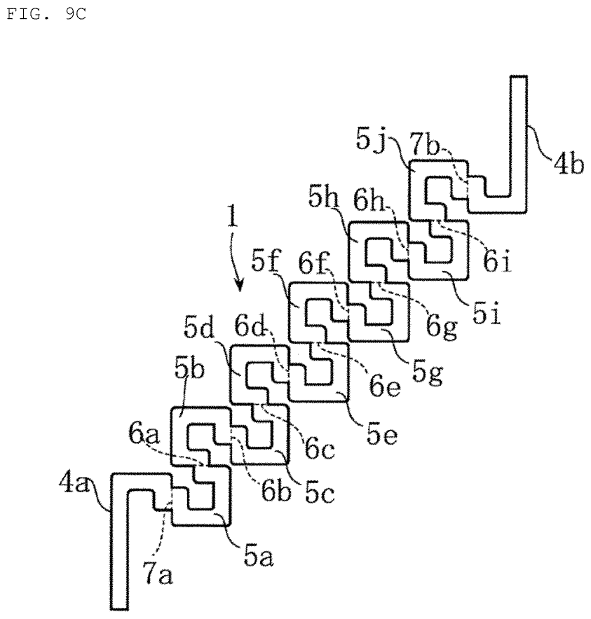

FIGS. 9A to 9C show a procedure for producing the continuous thin band 1.

First, as shown in FIG. 9A, a conductor plate 11 is prepared having a predetermined size desirably with a thickness T equal to or less than twice the skin depth d with respect to the driving frequency f of the coil component. Next, the conductor plate 11 undergoes punching and laser irradiation, and a cutout member 20 cut out into a stepped shape is obtained as shown in FIG. 9B. Then, the cutout member 20 undergoes punching at predetermined positions to have the cavity portions and the extended portions 4a and 4b, resulting in production of the continuous thin band 1 that is divided into the plurality of conductor portions 5a to 5j by the folding sites 7a, 6a to 6i, and 7b as shown in FIG. 9C.

FIGS. 10D to 10F are sectional views of a relevant part showing an embodiment of a procedure for producing the winding body, and show a case where the folding site 6a (see FIG. 9C) of the continuous thin band 1 undergoes the fold processing.

That is, as shown in FIG. 10D, the cutout portion 9 having a U-shaped section in the direction perpendicular to the folding site 6a is provided on one main surface of the folding site 6a such that the depth Dt is about ¼ to ¾ the thickness T of the continuous thin band 1 by a method such as cutting, etching, or shape transferring using a mold. In the other folding sites 7a, 6b to 6i, and 7b, the cutout portions 9 are similarly formed each on one of main surfaces so as to be inside after folding at these folding sites 7a, 6b to 6i, and 7b.

Then, the continuous thin band 1 in which the cutout portions 9 are formed is immersed in, for example, an insulating varnish solution at a predetermined temperature, and both main surfaces of the continuous thin band 1 undergoes application of insulating material to be coated with an insulating film.

Next, the continuous thin band 1 is folded by moving the conductor portion 5b toward the direction of arrow E as shown in FIG. 10E, and is further folded so that the conductor portion 5b overlaps the conductor portion 5a as shown in FIG. 10F, resulting in formation of the hollow recessed portion 10.

At the other folding sites 7a, 6b to 6i, and 7b in which the cutout portions are formed, a mountain fold and a valley fold are alternately repeatedly made as appropriate, which causes the continuous thin band 1 to be wound helically so that the cutout portions 9 are formed into the recessed portions 10 and the cavity portions communicate with each other. The winding body is thus produced.

As described above, the method for manufacturing the winding body includes steps of cutting out the continuous thin band 1 into a predetermined shape to provide the cavity portions 8a and 8b, forming the cutout portions 9 in the folding sites 7a, 6b to 6i, 7b where the continuous thin band 1 is folded, and folding the continuous thin band 1 at the folding sites 7a, 6b to 6i, 7b to form it into a helical shape with the cutout portion 9 formed into a recessed portion 10 and with the cavity portions 8a and 8b communicating with each other. Therefore, it is possible to efficiently manufacture the winding body with the good workability in which short-circuiting between the conductor portions, the occurrence of structural defects such as cracks, and the conductor loss can be suppressed.

FIG. 11 is a perspective view of a reactor as a coil component according to the present disclosure using the winding body.

The reactor includes a magnetic core 12 containing magnetic material and resin material, in which a coil conductor is embedded, and the coil conductor is formed of a winding body 13 of the present disclosure. The winding body 13 and the magnetic core 12 are housed in a case 14, and extended portions 4a and 4bof the winding body 13 project from an end of the case 14.

In this reactor as a coil component, the coil conductor is thus formed of the above winding body 13 described above. Therefore, it is possible to obtain a high-performance and high-quality coil component such as a reactor in which the conductor loss is suppressed, protrusion of a part of the conductor of the winding body 13 to the outside of the winding body can be suppressed, short-circuiting in the winding can be avoided, and the occurrence of structural defects such as cracks is also suppressed.

This reactor can be easily produced as follows.

First, a core material in which magnetic powder and resin material are mixed in a predetermined ratio is prepared. Next, after setting the winding body 13 in a mold having a predetermined shape, a cavity of the mold is supplied and filled with the core material, which is pressurized and heated to be cured, resulting in integral formation of a molded body with the winding body 13 embedded in the magnetic core 12. Then, the molded body is taken out from the mold, and is fitted into the case 14 to be housed in the case 14, whereby the reactor can be produced.

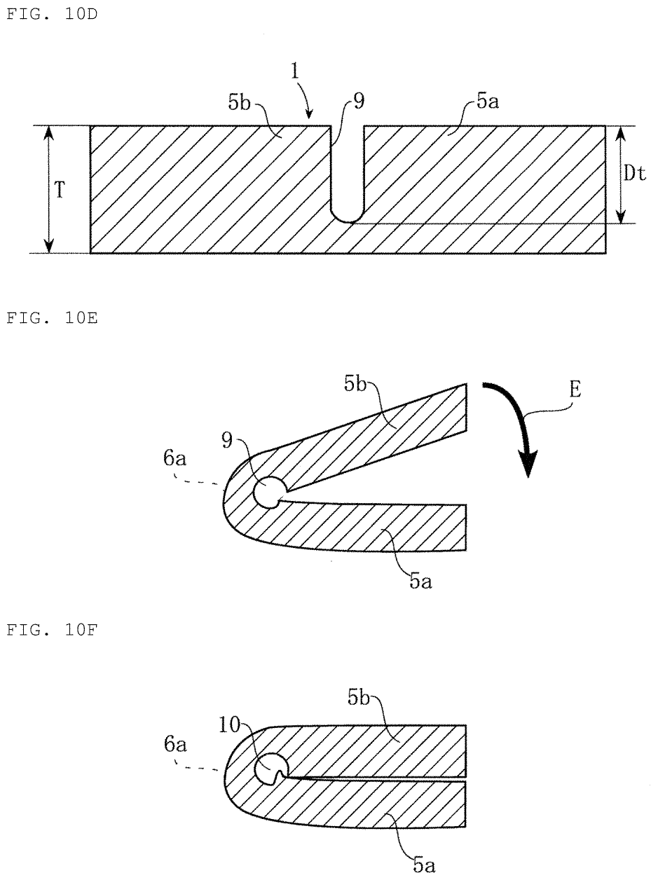

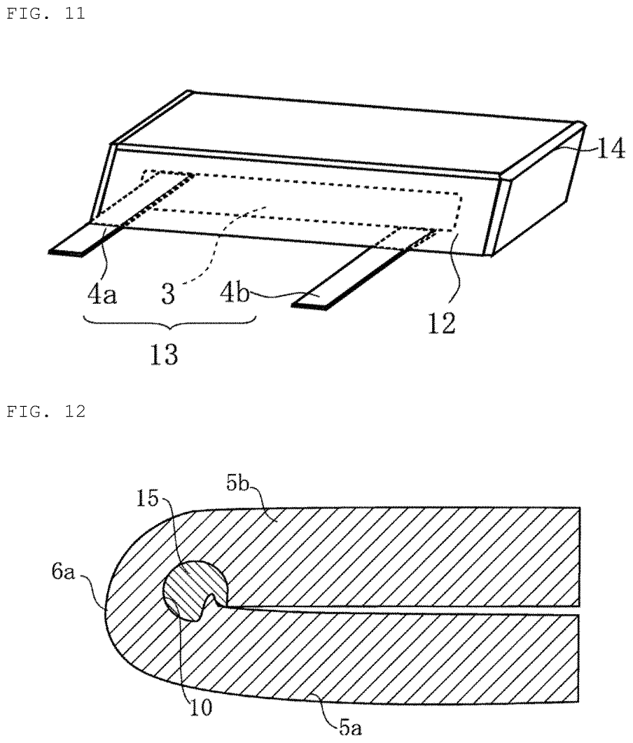

FIG. 12 is a sectional view of a relevant part showing another embodiment of the winding body.

That is, in the above embodiment, the recessed portion 10 is hollow, but in this embodiment, the recessed portion 10 is filled with insulating resin 15 such as epoxy. This allows for further improvement of the insulating property, and for improvement of the heat dissipation by efficiently releasing heat generated in the winding body to the outside.

In a filling method, the insulating resin may be injected between the conductor portions 5a to 5j after folding the continuous thin band 1 at the folding sites 7a, 6a to 6i, and 7b, or the insulating resin may be applied in advance to the continuous thin band 1 before the fold processing.

In this another embodiment, the insulating resin 15 is injected in the recessed portion 10 to fill it, but may at least partly fill the recessed portion 10. The insulating resin 15 may fill the entire inside of the recessed portion 10 or may fill the gap between the conductor portion 5a and the conductor portion 5b.

The present disclosure is not limited to the above embodiments, and various modifications can be made as long as the gist thereof is not changed. In the above embodiments, the winding body is obtained by repeatedly folding the continuous thin band 1 cut out to have the stepped shape into a mountain fold and a valley fold alternately. However, it is important in the present disclosure to form a cutout portion in one surface of the folding site and to make the cutout portion formed into a recessed portion after folding. Thus, the shape of the continuous thin band is not limited, and a plurality of consecutive mountain folds may be made, or a plurality of consecutive valley folds may be made.

Further, in the above embodiments, the cavity portions and the extended portions 4a and 4bare formed by punching at predetermined positions of the cutout member 20 after cutting out the cutout member 20 into the stepped shape. However, it is also desirable to form the cutout member 20, the cavity portions 8a and 8b, and the extended portions 4a and 4bby punching at the same time in one step.

Further, in the above embodiments, the insulating film is provided on the continuous thin band 1 before the fold processing. However, the insulating film may be provided after the fold processing.

Next, examples of the present disclosure will be specifically described.

### EXAMPLE 1

A Cu thin band with a thickness of 0.3 mm and a width of 10 mm was prepared, and an example sample and a comparative example sample were produced for confirming the workability.

(Example Sample)

FIGS. 13 to 15 are images obtained with an optical microscope, showing a procedure of the fold processing for the Cu thin band of the example sample in which a cutout portion was formed.

First, as shown in FIG. 13, a folding site 52 of a Cu thin band 51 was etched, and a U-shaped cutout portion 53 was formed. The depth Dt of the cutout portion 53 was about 3/4 the thickness T of the Cu thin band 51 (about 0.23 mm).

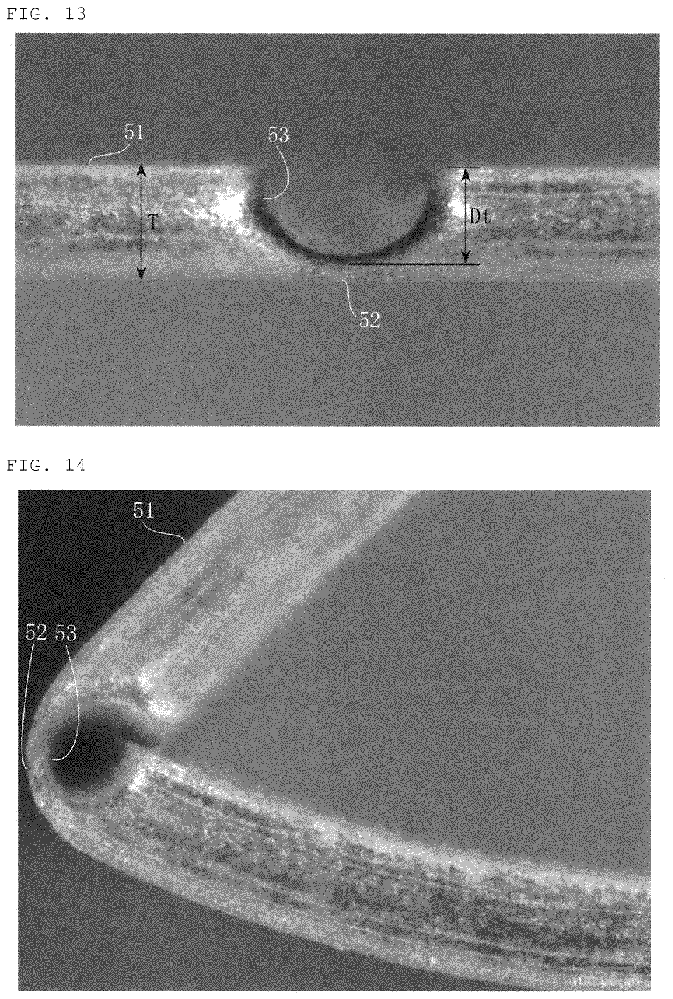

Next, as shown in FIG. 14, the Cu thin band 51 was folded at the folding site 52 in an overlapping manner, and was further folded, so that the cutout portion 53 was formed into a hollow recessed portion 54 as shown in FIG. 15. An inside part of the folding site 52 was stowed in the recessed portion 54 without protruding to the outside of the Cu thin band 51.

As a result, it is considered that, when a winding body is formed by helically winding a continuous thin band in which a cutout portion is formed, short-circuiting in the winding can be suppressed without contact between the conductors inside the folding site of the winding body.

Next, the example sample after the fold processing was imaged by a scanning electron microscope (SEM) to be observed.

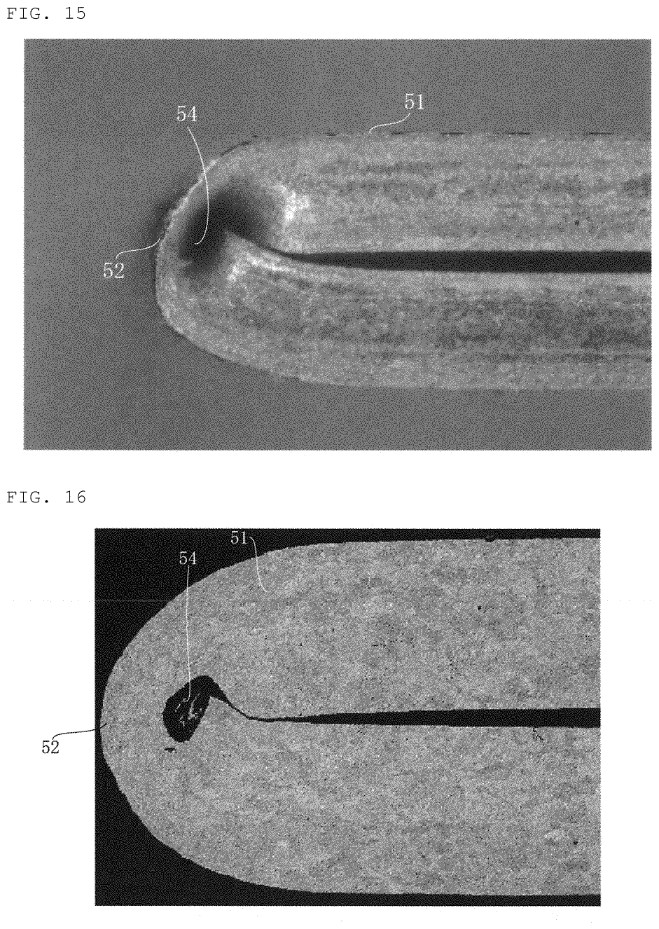

FIG. 16 is an SEM image obtained at 200-fold magnification, and FIG. 17 is an enlarged SEM image obtained at 1000-fold magnification for the SEM image of FIG. 16.

FIG. 17 shows that, when a compressive stress was applied to the inside part of the Cu thin band 51 by the fold processing, the hollow recessed portion 54 acted as a buffer and thus the occurrence of structural defects such as cracks could be suppressed.

(Comparative Example Sample)

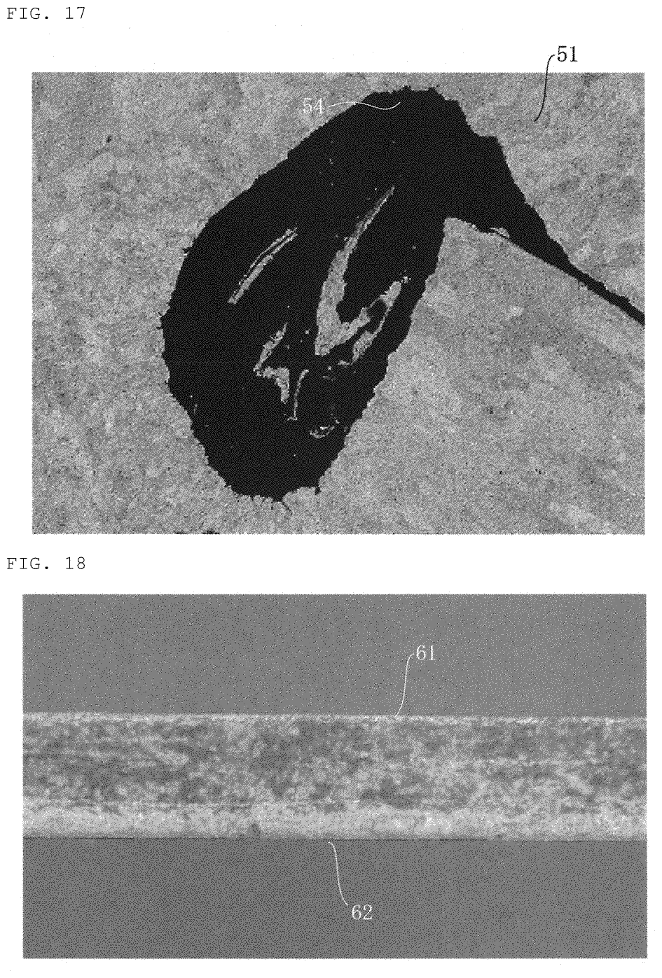

FIGS. 18 to 21 are images obtained with an optical microscope, showing a procedure of the fold processing for the Cu thin band of the comparative example sample in which no cutout portion was formed.

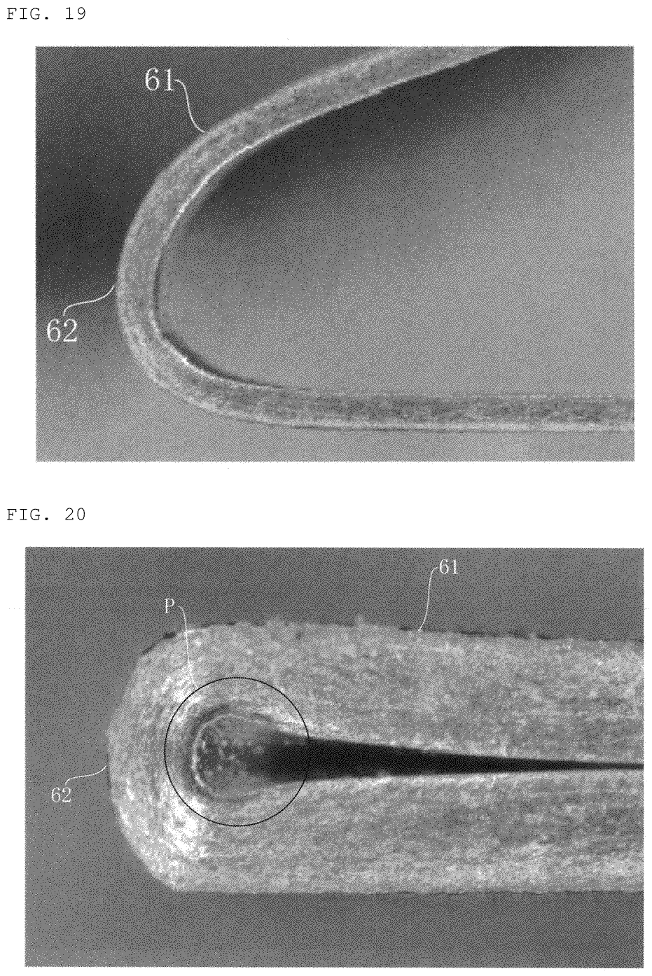

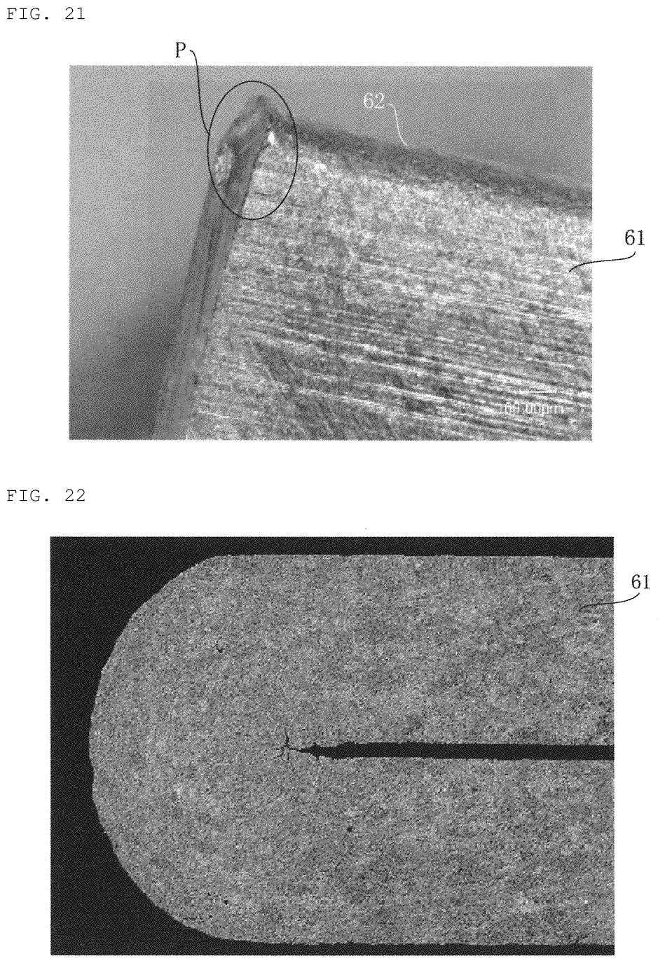

That is, as shown in FIG. 18, a Cu thin band 61 with a thickness of 0.3 mm and a width of 10 mm having a folding site 62 was prepared. As shown in FIG. 19, the Cu thin band 61 was folded into a U shape at the folding site 62, and was further folded as shown in FIGS. 20 and 21. It turned out that an inside part of the Cu thin band 61 was then folded and compressed and thus a part of the folded area protruded in the width direction as shown in part P in the figure. As a result, when a winding body is formed by using a continuous thin band having no cutout portion like the comparative example sample, there is a risk that a short circuit in the winding will occur due to contact between the conductors in the folded area of the winding body.

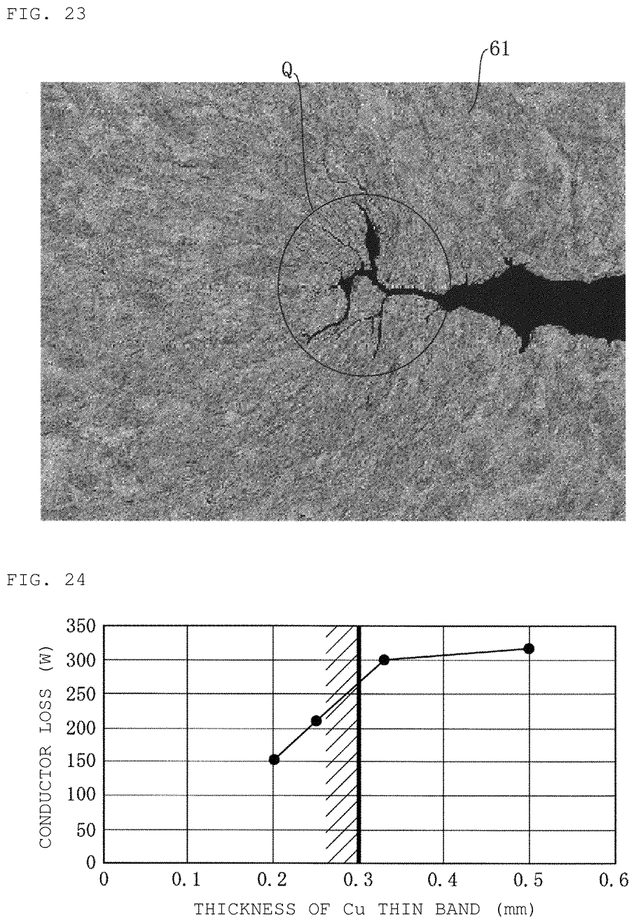

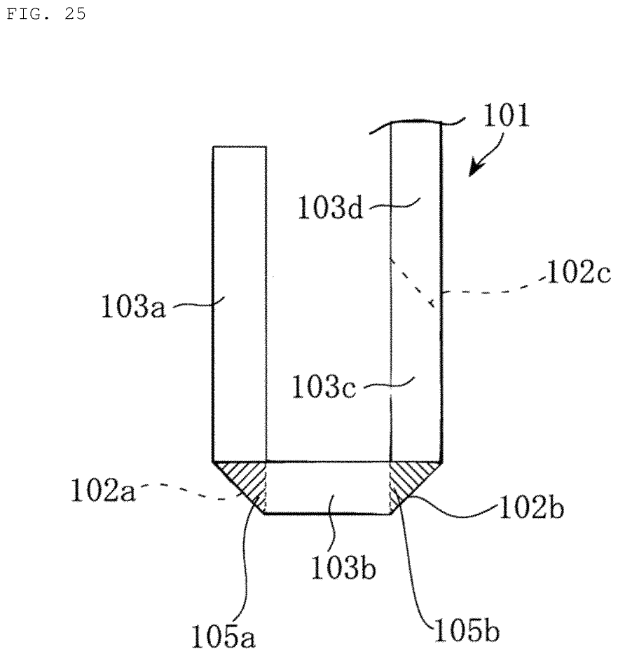

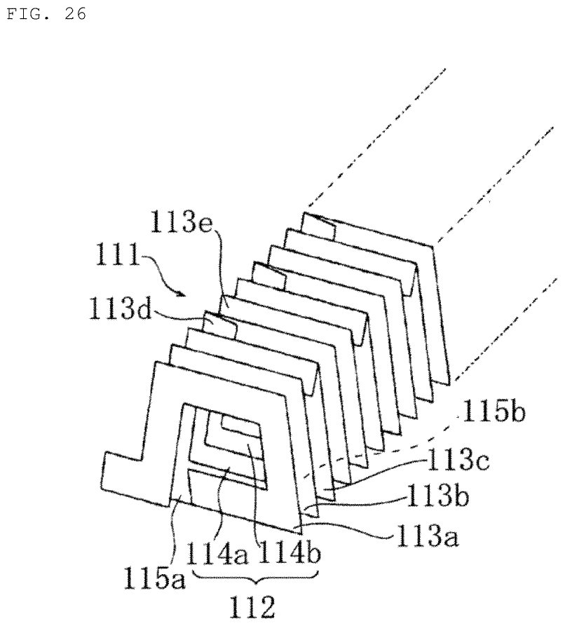

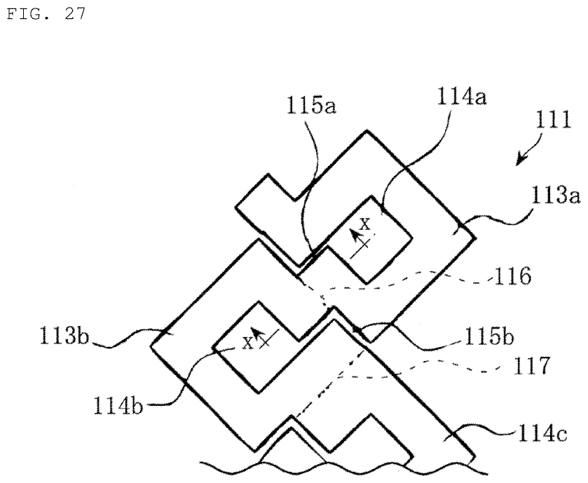

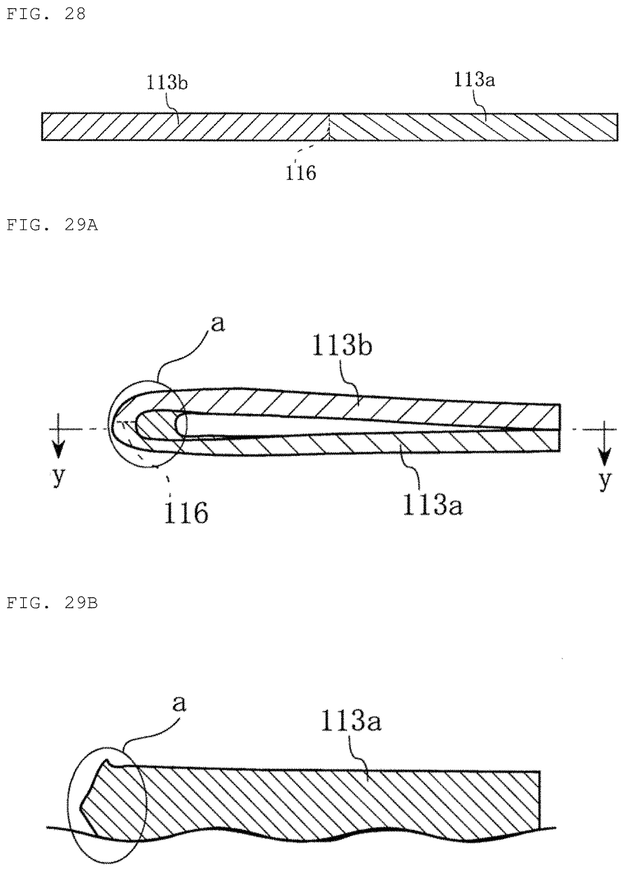

FIG. 22 is an SEM image of the comparative example sample obtained at 200-fold magnification, and FIG. 23 is an enlarged SEM image obtained at 1000-fold magnification for the SEM image of FIG. 22.

As shown in FIG. 23, a compressive stress was applied to the inside part of the Cu thin band 61 by the fold processing, and thus cracks originating at the folding site arose as shown in part Q in the figure.

As described above, the flat Cu thin band 61 of the comparative example sample was simply folded, so that the overlapping part of the conductor protruded in the width direction and structural defects such as cracks arose due to the compressive stress applied to the folding site by the fold processing.

On the other hand, the Cu thin band 51 of the example sample, which was provided with the cutout portion 53 at the folding site 52, was folded at the folding site 52, so that the cutout portion 53 was formed into the hollow recessed portion 54 after folding, allowing for stowing the inside of the folding site 52 in the recessed portion 54 and for suppressing the protrusion in the width direction. Further, it was confirmed that, when the compressive stress was applied during the fold processing, the recessed portion 54 acted as a buffer and thus the occurrence of structural defects such as cracks could be suppressed.

### EXAMPLE 2

Magnetic field analysis software is used to simulate a relationship between a Cu thin band (continuous thin band) and a conductor loss for Cu thin bands having thicknesses T of 0.2 mm, 0.33 mm, and 0.5 mm, respectively, when the Cu thin bands are energized with an alternating current having an effective value of 28 A (peak-peak value: 80 A) under a condition that a driving frequency f of a coil component is 200 kHz.

FIG. 24 shows, as a result of the simulation, the relationship between the thickness of the Cu thin band and the conductor loss. In the figure, the horizontal axis is the thickness (mm) of the Cu thin band, and the vertical axis is the conductor loss (W).

As is clear from FIG. 24, the conductor loss sharply decreases when the thickness of the Cu thin band is 0.3 mm or less.

Meanwhile, the skin depth d of the Cu thin band can be calculated by the mathematical formula (1) discussed above.

Since the electrical resistivity p of Cu is 1.68×10⁻⁸ Ω·m and the absolute magnetic permeability μ of Cu is 1.2×10⁻⁶ H/m, the skin depth d of the Cu thin band at the driving frequency of 200 kHz is 0.15 mm

As a result, it has turned out that the conductor loss is sharply reduced by making the thickness of the Cu thin band equal to or less than twice a skin depth with respect to the driving frequency.

In addition, a result of simulation in which the driving frequency varies in a range of 10 kHz or more and less than 200 kHz (i.e., from 10 kHz to 200 kHz) shows that the conductor loss can be sharply reduced by making the thickness of the Cu thin band equal to or less than twice a skin depth with respect to the driving frequency regardless of a value of the driving frequency.

This confirms the effectiveness of making the thickness T of the continuous thin band equal to or less than twice the skin depth d with respect to the driving frequency f for reducing the conductor loss.

There are realize a winding body with the good workability in which short-circuiting in winding and the occurrence of structural defects such as cracks can be suppressed and the conductor loss can also be effectively reduced, and a coil component such as a reactor using this winding body.

What is claimed is:

1. A winding body for a coil component, the winding body comprising:
a continuous thin band wound helically,
the continuous thin band having a plurality of folding sites and being partitioned into a plurality of conductor portions by the folding sites to be folded in an overlapping manner, and
the folding sites each having a recessed portion.

2. The winding body according to claim 1, wherein
the recessed portion is configured into a hollow shape.

3. The winding body according to claim 1, wherein
the recessed portion has an average depth larger than a gap between the conductor portions.

4. The winding body according to claim 1, wherein
the recessed portion is at least partly filled with insulating resin.

5. The winding body according to claim 1, wherein
the continuous thin band is configured such that at least two successive conductor portions as one pair are in a stepped shape in a sheet-like unfolded state, and
the continuous thin band in the stepped shape is folded at the folding sites.

6. The winding body according to claim 1, wherein
the continuous thin band has a thickness equal to or less than twice a skin depth with respect to a driving frequency of the coil component.

7. The winding body according to claim 6, wherein
the continuous thin band has the thickness equal to or greater than the skin depth at the driving frequency of the coil component.

8. The winding body according to claim 1, wherein
the continuous thin band has a rectangular wire shape.

9. The winding body according to claim 1, wherein
the continuous thin band has a surface coated with an insulating film.

10. The winding body according to claim 2, wherein
the recessed portion has an average depth larger than a gap between the conductor portions.

11. The winding body according to claim 2, wherein
the recessed portion is at least partly filled with insulating resin.

12. A method for manufacturing a winding body for a coil component by which the winding body is produced through folding and helically winding a continuous thin band, the method comprising
cutting out the continuous thin band into a predetermined shape to have cavity portions;
forming a cutout portion in at least a part of a folding site where the continuous thin band is folded; and
folding the continuous thin band at the folding site to form the continuous thin band into a helical shape with the cutout portion formed into a recessed portion and with the cavity portions communicating with each other.

13. The method for manufacturing a winding body according to claim 12, further comprising:
filling at least a portion of the recessed portion with insulating resin.

14. The method for manufacturing a winding body according to claim 12, wherein
the predetermined shape is stepped.

15. The method for manufacturing a winding body according to claim 12, wherein
the cutout portion is configured to have a U-shape in a cross section in a direction perpendicular to the folding site.

16. The method for manufacturing a winding body according to claim 12, wherein
the continuous thin band has a thickness equal to or less than twice a skin depth with respect to a driving frequency of the coil component.

17. The method for manufacturing a winding body according to claim 13, wherein
the predetermined shape is stepped.

18. A coil component comprising:
a magnetic core containing magnetic material; and
a coil conductor,
wherein the coil conductor is configured of the winding body according to claim 1.

19. A coil component comprising:
a magnetic core containing magnetic material; and
a coil conductor,
wherein the coil conductor is configured of the winding body according to claim 2.

20. The coil component according to claim 18, wherein
the coil component is a reactor.
